(19) United States
(12) Patent Application Publication
(10) Pub. No.: US 2015/0280278 A1
(43) Pub. Date: Oct. 1, 2015

(54) AMORPHOUS POLYAMIDE DERIVED FROM AROMATIC DICARBOXYLIC ACID AS A BINDER FOR LITHIUM ION BATTERY ELECTRODE

(71) Applicant: E I DU PONT DE NEMOURS AND COMPANY, Wilmington, DE (US)

(72) Inventor: Steven R ORIANI, Landenberg, PA (US)

(21) Appl. No.: 14/669,467

(22) Filed: Mar. 26, 2015

Related U.S. Application Data
(60) Provisional application No. 61/971,144, filed on Mar. 27, 2014.

(51) Int. Cl. H01M 10/052; H01M 4/134; H01M 4/1395; H01M 4/66; H01M 4/525; H01M 4/38; H01M 4/62; H01M 4/04; H01M 4/505

(52) U.S. Cl. CPC H01M 10/052; H01M 4/0404; H01M 4/134; H01M 4/1395; H01M 4/505; H01M 4/525; H01M 4/386; H01M 4/387; H01M 4/623; H01M 4/661; H01M 4/669; H01M 4/622; H01M 2004/027

(57) ABSTRACT

Disclosed are electrodes, lithium ion batteries, and a process for production of electrodes for lithium ion batteries comprising amorphous polyamide binders, wherein the amorphous polyamide comprises at least 50 mole % of repeating units derived from aromatic dicarboxylic acids, and has a glass transition temperature of at least 80° C.

### CROSS REFERENCE TO RELATED APPLICATION

This application claims priority under 35 U.S.C. §119(e) from U.S. Provisional Patent Application No. 61/971,144, filed Mar. 27, 2014, hereby incorporated herein by reference in its entirety.

### FIELD OF THE INVENTION

The invention is directed to an electrode for a lithium ion battery comprising amorphous polyamide derived from aromatic dicarboxylic acids and to a process for producing said electrode, and to a lithium ion battery comprising said electrode.

### BACKGROUND OF THE INVENTION

Since commercial lithium ion batteries were first developed by Sony in the early 1990s, they have been widely adopted in portable electronics such as laptops, tablets and smartphones due to their high energy density, high working voltages, and excellent flexibilities in shapes and sizes. These properties allow lithium ion batteries to accommodate demanding needs from rapidly evolving electronic devices more readily than conventional secondary batteries. Lithium ion batteries are considered as desirable alternative energy sources in emerging markets such as electrified vehicles and energy storage, which will bring about new opportunities and challenges simultaneously.

A lithium ion battery (LIB) typically comprises four components including a negative electrode (anode), a positive electrode (cathode), an electrolyte and a separator, which work in harmony to interconvert chemical energy into electrical energy reversibly as current flow reverses during charge and discharge processes. The electrolyte may be a mixture of organic carbonates containing lithium salts which flow across the separator and carry current through the battery. The organic carbonates include ethylene carbonate, ethyl methyl carbonate, diethyl carbonate, or combinations thereof. The lithium salts include LiPF₆, LiBF₄, LiAsF₆, LiClO₄, LiCF₃SO₃, LiN(SO₂CF₃)₂ or combinations thereof. The separator is commonly made from a stretched and thus micro-porous multilayered film of polyethylene, polypropylene or combinations thereof.

The positive and negative electrodes (cathode and anode) of a LIB comprise particulate material, sometimes referred to as active material, capable of storing and releasing lithium ions. Common active materials for anodes comprise carbon (graphite or graphene), and for cathodes comprise lithium metal oxides, mixed metal oxides, or metal salts, typically lithium metal salts. Typically electrodes are constructed by applying active material onto a current collector in the presence of a binder that affords cohesion between active materials and their adhesion to the current collector. This permits facile charging and discharging of the battery, by forming a cohesive layer of active material that is well-adhered to the current collector substrate.

Typical polymeric binders for electrodes include polyvinylidene fluoride (PVDF) and semi-crystalline copolymers of vinylidene fluoride and hexafluoropropylene (VF2-HFP). These polymers provide good adhesion to the current collector, acceptable stability to electrochemical oxidation and reduction, and solubility in N-methyl-2-pyrrolidone (NMP). NMP is a high flashpoint solvent preferred by the lithium ion battery industry for casting electrodes.

Because the binder component of an electrode takes up space that could be occupied by active material, battery manufacturers strive to minimize the binder content in order to maximize the charge/discharge capacity of the battery. Therefore, an NMP-soluble binder that can maintain strong adhesion to metal at low levels in the electrode, while also providing electrochemical stability, is needed for improved lithium ion batteries.

A number of alternative electrode binders have been proposed to improve upon the performance of conventional PVDF binders.

JP2002251999 discloses binders comprising polymers having a hydrocarbon backbone and pendant amide groups.

JP2013214394 discloses electrodes comprising two layers of active material using different binders in each layer. The layer in contact with the current collector comprises a binder having a glass transition temperature (Tg) greater than 30° C., desirably selected from the group comprising polyacrylonitrile, polyamide, and poly(meth)acrylic acid. The second layer, applied to the first layer in contact with the current collector, comprises a binder having a Tg less than 0° C. The two-layer electrode structure solves the problem of cracking in a structure comprising only one layer with a binder having a Tg greater than 30° C. There is no teaching to use an amorphous polyamide derived from aromatic dicarboxylic acids as a binder.

JP2012234707 discloses electrodes comprising a binder using two water-dispersible polymers. The first polymer is a polyamide in which at least 50 mole % of the dicarboxylic acid component comprises aliphatic dimerized fatty acids of 18 carbons or greater. The second component is an acid-containing polyolefin. Thirty to sixty parts of the dimer-acid polyamide is combined with 100 parts of the acid-containing polyolefin.

JP2012216517 discloses an electrode binder composition obtained by free radical emulsion polymerization of a mixture of ethylenically unsaturated monomer and polyamide, wherein the average emulsion particles are less than or equal to 2 microns in size. The dicarboxylic acid residues in the polyamide are derived primarily from aliphatic dicarboxylic acids, e.g., oleic and linoleic acids.

JP2012164521 discloses an electrode binder composition comprising a polyamide and a fluoropolymer in which the dicarboxylic acid component of the polyamide comprises at least 50 mole % of aliphatic dimerized fatty acid of 18 carbons or greater. The fluoropolymer is present in the range of 20 to 100 parts based on 100 parts of the polyamide.

JP2012059648 discloses an electrode binder composition comprising a polyamide in which the dicarboxylic acid component of the polyamide comprises at least 50 mole % of aliphatic dimerized fatty acid of 18 carbons or greater.

JP2012033438 discloses a cathode composition comprising a blend of PVDF and 38% to 70% polyamide. The polyamide desirably has a crystallization temperature exceeding 300° C., and therefore teaches away from the use of amorphous polyamides.

JP08298122 discloses electrodes comprising binders of methoxymethyl substituted polyamides, for example methoxymethyl substituted PA66.

JP08273670 discloses electrodes comprising binders of n-methoxymethylated polyamides of at least 18% substitution.

U.S. Pat. No. 5,380,606 discloses a negative electrode for a secondary battery comprising a carbon material and a mixed binder comprising polyamide, polyvinylpyrrolidone, or hydroxyalkylcellulose, and polyamic acid.

JP04144059 and JP04144060 disclose a negative electrode plate for an alkaline battery produced by kneading a mixture of polyamide, active material, and solvent, spreading the mixture on the electrode plate, and evaporating the solvent.

U.S. Patent Application Publication 2013/0273423 discloses water soluble binder compositions for an electrode comprising a polymer binder having at least one amide group and one carboxylate group in the repeating unit of the polymer.

U.S. Patent Application Publication 2014/0312268 discloses a composition comprising an ethylene elastomer and a solvent wherein the composition is a binder for a lithium ion battery; the elastomer comprises or is produced from repeat units derived from ethylene and one or more comonomer selected from the group consisting of an alky(meth)acrylate; and the elastomer comprises a curing agent. The elastomer can further comprise or can be further produced from repeat units derived from a second alky(meth)acrylate, 2-butene-1,4-dioic acid or its derivative, or both.

U.S. Patent Application Publication 2014/0312282 discloses a composition comprising an ethylene copolymer and a solvent wherein the composition is a binder for a lithium ion battery; the ethylene copolymer comprises or is produced from repeat units derived from ethylene and a comonomer selected from the group consisting of an ∝,β-unsaturated monocarboxylic acid or its derivative, an ∝,β-unsaturated dicarboxylic acid or its derivative, an epoxide-containing monomer, a vinyl ester, or combinations of two or more thereof; and the composition can further comprises a curing agent to crosslink the ethylene copolymer.

U.S. Patent Application Publication 2014/0370382 discloses a composition comprising an ethylene copolymer and a polyetherimide, polyamideimide, polycarbonate, polyetheretherketone, polysulfone or polyethersulfone wherein the ethylene copolymer comprises or is produced from repeat units derived from ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; and the composition can further comprise a curing agent to crosslink the ethylene copolymer. The composition is useful as a binder for a lithium ion battery.

U.S. Patent Application Publication 2014/0370383 discloses a composition comprising an ethylene copolymer and a halogenated polymer, wherein the ethylene copolymer comprises or is produced from repeat units derived from ethylene and a comonomer selected from the group consisting of an α,β-unsaturated monocarboxylic acid or its derivative, an α,β-unsaturated dicarboxylic acid or its derivative, an epoxide-containing monomer, a vinyl ester, or combinations of two or more thereof; and the composition can further comprise a curing agent to crosslink the ethylene copolymer. The composition is useful as a binder for a lithium ion battery.

Still, there is a need for improved binders for lithium ion battery electrodes, particularly for positive electrodes, that are soluble in NMP, provide high adhesion to current collectors, and yield favorable battery performance.

### SUMMARY OF THE INVENTION

The invention provides a composition for an electrode of a lithium ion battery comprising discrete particles of active material dispersed in a binder composition comprising an amorphous polyamide, wherein the amorphous polyamide comprises at least 50 mole % of the repeating units derived from one or more aromatic dicarboxylic acids and has a glass transition temperature of at least 80° C.

The invention also provides an electrode for a lithium ion battery wherein the composition above is coated onto a current collector. The invention also provides a lithium ion battery comprising the binder composition or the electrode composition described above.

The invention also provides a process for producing an electrode for a lithium ion battery comprising the steps:
i) providing a composition comprising amorphous polyamide comprising at least 50 mole % of the repeating units derived from one or more aromatic dicarboxylic acids and having a glass transition temperature of at least 80° C.;
ii) providing active material in particulate form, solvent such as NMP, and a current collector;
iii) dissolving the composition comprising amorphous polyamide in the solvent;
iv) mixing the solution comprising amorphous polyamide with active material to form a slurry;
v) applying the slurry comprising amorphous polyamide, active material, and solvent to a current collector; and
vi) removing the solvent to produce an electrode.

### DETAILED DESCRIPTION OF THE INVENTION

All references disclosed herein are incorporated by reference.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present). As used herein, the terms “a” and “an” include the concepts of “at least one” and “one or more than one”.

When the term “about” is used in describing a value or an end-point of a range, the disclosure should be understood to include the specific value or end-point referred to.

Unless stated otherwise, all percentages, parts, ratios, etc., are by weight. Further, when an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When a component is indicated as present in a range starting from 0, such component is an optional component (i.e., it may or may not be present). When present an optional component may be at least 0.1 weight % of the composition or copolymer.

When materials, methods, or machinery are described herein with the term “known to those of skill in the art”, “conventional” or a synonymous word or phrase, the term signifies that materials, methods, and machinery that are conventional at the time of filing the present application are encompassed by this description. Also encompassed are materials, methods, and machinery that are not presently conventional, but that may have become recognized in the art as suitable for a similar purpose.

As used herein, the term “copolymer” refers to polymers comprising copolymerized units resulting from copolymerization of two or more comonomers and may be described with reference to its constituent comonomers or to the amounts of its constituent comonomers such as, for example “a copolymer comprising ethylene and 15 weight % of acrylic acid”. A description of a copolymer with reference to its constituent comonomers or to the amounts of its constituent comonomers means that the copolymer contains copolymerized units (in the specified amounts when specified) of the specified comonomers.

The terms “binder” and “binder composition” refer to the nonconductive materials that provide a matrix for the particulate active electrode materials that holds the particles together and adheres them to the current collector of the electrode.

The term “electrode composition” refers to the combination of binder, active material, and optional materials such as conductivity aids, dispersants and the like that when applied to a current collector form an electrode.

The terms “slurry” and “slurry composition” refers to the combination of binder, active materials and optional materials mixed with a solvent that is applied to the conductivity collector to prepare an electrode.

The term “current collector” is a conductive material that serves as a substrate for the electrode composition and connects the battery with the other parts of the electrical circuit to provide a pathway for current to flow into and out of the battery.

The term “electrode” is the combination of electrode composition and current collector.

This invention is directed to binders for electrodes for use in lithium ion batteries. The binder in an electrode of lithium ion battery provides cohesion between active materials and adhesion to the current collector. Since trends in lithium ion battery are moving toward slimmer and more flexible structures, the role of the binder to accommodate functional needs becomes even more demanding. The compositions described herein provide improved adhesion over previous binder materials.

It has been found that by using amorphous polyamide to bond the particulate active materials in the electrode composition to a current collector, high binding strength between the current collector and the active material layer can be achieved. The high binding strength allows binder content in the electrode to be reduced, so that the battery contains more active material per unit volume. Furthermore, electrodes comprising amorphous polyamide binder are simple to produce, requiring no additional complexity to manufacture than a conventional electrode using PVDF as a binder.

Most polyamides are semi-crystalline polymers, meaning they exhibit a melting peak temperature as measured according to ASTM D3418-08. Examples of semi-crystalline polyamides include polyamide 6, 6/6, 6/10, 6/12, 7, 10/10, 11, 12, and nylon multi-polymers which combine structural units of various polyamides, for example those commercially available from E.I DuPont de Nemours under the trade name Elvamide®. Polyamides derived from the reaction of dimer fatty acids and diamines as disclosed in U.S. Pat. No. 2,450,940 are typically semi-crystalline, having melting points ranging from 70° C. to almost 200° C.

In general, semi-crystalline polyamides can be dissolved only in a select class of protic solvents such as formic acid, sulfuric acid, and some aliphatic amines. Certain nylon multi-polymers and fatty acid dimer polyamides may be soluble in alcohols such as ethanol. All of these solvents, however, present difficulties for use in the production of lithium ion battery cathodes, such as explosion hazards, undesirable interactions with active materials, and potential contamination of the battery by residuals. Furthermore, when used as a binder for an electrode, the binding strength of semi-crystalline polyamides tends to be low. Without being bound by theory, the shrinkage of the semi-crystalline polyamide as a result of the crystallization process may create stress at the interface of the polymer and the current collector, thereby weakening the binding strength.

Amorphous polyamides, however, can be readily dissolved in a variety of polar solvents, including N-methyl-2-pyrrolidone (NMP), a solvent widely used for electrode production. By amorphous is meant that the heat of fusion, if any, is less than about 2 J/g as measured according to the method of ASTM D3418-08 for determination of first-order thermal transitions. Preferably, the heat of fusion is less than 1 J/g, and most preferably the heat of fusion is zero.

The amorphous polyamides useful as binders for electrodes in lithium ion batteries comprise at least 50 mole % of repeating units derived from the reaction of one or more aromatic dicarboxylic acids with one or more diamines. By aromatic dicarboxylic acid is meant any molecule in which exactly two carboxylic acid groups are substituted onto mono- or polycyclic aromatic hydrocarbon radicals. Aromatic dicarboxylic acids include, for example, terephthalic acid, isophthalic acid, and orthophthalic acid. Amorphous polyamides comprising aromatic dicarboxylic acids are well known in the art, and include those disclosed in U.S. Pat. Nos. 3,150,113, 3,597,400, and 4,207,411. The aromatic dicarboxylic acid may be esterified prior to polymerization with a diamine to form the polyamide, as disclosed in PCT Patent Application Publication WO99/18144, or the carboxylic acid groups may be converted to an acyl halide prior to polymerization, to improve reactivity. To interrupt the regularity of the polymer molecule and prevent crystallization, it is often desirable to use a mixture of aromatic dicarboxylic acids to form the amorphous polyamide. For example, mixtures of terephthalic acid and isophthalic acid (or their derivatives) may be used. Preferably, the amorphous polyamide comprises at least 75 mole % of repeating units derived from aromatic dicarboxylic acids. Most preferably all the repeating units in the amorphous polyamide are derived from the reaction of one or more aromatic dicarboxylic acids and one or more diamines.

Although the diamine component of the amorphous polyamide is not particularly limited, preferably the diamine component comprises one or more aliphatic diamines, such as ethylene diamine, 1,4-butanediamine, 1,6-hexanediamine, trimethyl-1,6-hexanediamine, or the like. Most preferably, the diamine component is selected from 1,6-hexanediamine or trimethyl-1,6-hexanediamine. Aliphatic diamines are advantageously used as the diamine component of the amorphous polyamide because aromatic diamines in combination with aromatic diacids tend to produce insoluble, crystalline polyamides. In addition, aliphatic diamines are more reactive towards unmodified aromatic diacids, and therefore the polymerizations require less technical effort. Of note are amorphous polyamides comprising 1,6-hexanediamine, terephthalic acid and isophthalic acid.

The amorphous polyamides useful as binders for electrodes in lithium ion batteries exhibit a glass transition temperature as determined by the method of ASTM D3418-08 of at least 80° C., preferably at least 100° C., and most preferably at least 120° C. If the glass transition temperature is less than about 80° C., the electrode may fail due to heat generated during operation of the battery.

The amorphous polyamides may be combined with other polymers in various ways to form a binder for an electrode. In one embodiment, a solution in NMP of amorphous polyamide and one or more other polymers may be produced by adding the separate polymers to NMP and dissolving them. The solution in NMP of amorphous polyamide and one or more other polymers may then be combined with active materials and a current collector to form an electrode. Examples of polymers soluble in NMP that may be combined with amorphous polyamides include fluoropolymers such as PVDF, vinylidene fluoride or vinyl fluoride copolymers of hexafluoropropylene (HFP), tetrafluoroethylene (TFE), perfluoromethylvinyl ether (PMVE). Other polymers that can be combined with the amorphous polyamide in the binder composition include polymers with ester-bearing side chains such as polymethylmethacrylate, and polyacrylate polymers comprising acrylate monomers such as methyl acrylate, ethyl acrylate, butyl acrylate, hexyl acrylate, 2-ethylhexyl acrylate, or 2-methoxyethyl acrylate, optionally copolymerized with varying amounts of ethylene and/or acid-containing comonomers useful as cross-linkable cure sites. Particularly preferred are amorphous polyacrylate elastomers comprising methylacrylate, ethylacrylate, butylacrylate, or 2-methoxyethylacrylate, and less than 80 mole % ethylene, preferably less than 70 mole % of ethylene. Notable polyacrylate polymers comprise less than about 2 weight %, less than about 5 weight % or less than about 10 weight % of ethylene. Other polyacrylate copolymers include from 10 about to about 80 weight % of ethylene. Such acrylic elastomers include Vamac® from E.I du Pont de Nemours (DuPont), HyTemp® and Nipol® from Zeon Chemicals, Noxtite® from Unimatic Corp., TOA Acron® from Tohpe Corp., and Denka ER® from Denki Kagaku Kogyo KK. Copolymers of ethylene and vinyl acetate, comprising at least 40 weight % of vinyl acetate, are also preferred as NMP-soluble polymers for combining with amorphous polyamides. Such ethylene vinyl acetate polymers include Elvax® from DuPont, and Levapren® from Lanxess Corp.

Of note are copolymers comprising ethylene and at least one alkyl acrylate, with or without an acid cure site. These elastomeric copolymers include copolymers comprising

(a) from 13 to 50 weight % of copolymerized units of ethylene;

(b) from 50 to 80 weight % of copolymerized units of an alkyl acrylate; and

(c) from 0 to 7 weight % of copolymerized units of a monoalkyl ester of 1,4-butene-dioic acid, wherein all weight percentages are based on total weight of components (a) through (c) in the copolymer.

The copolymer may contain monoalkyl esters of 1,4-butene-dioic acid moieties that function as cure sites at a loading from about 0.5 to 7 weight percent of the total copolymer (preferably from 1 to 6 weight % and more preferably from 2 to 5 weight %). Thus, a preferred copolymer is derived from copolymerization of from 15 to 50 weight % of ethylene; from 50 to 80 weight % of an alkyl acrylate; and from 2 to 5 weight % of a monoalkyl ester of 1,4-butene-dioic acid.

The alkyl acrylates have up to 8 carbon atoms in the pendent alkyl chains, which can be branched or unbranched. For example, the alkyl groups may be methyl, ethyl, n-butyl, iso-butyl, hexyl, 2-ethylhexyl, n-octyl, iso-octyl, and other alkyl groups. Thus, the alkyl acrylates used in the preparation of the copolymers may be selected from methyl acrylate, ethyl acrylate, n-butyl acrylate, iso-butyl acrylate, hexyl acrylate, 2-ethylhexyl acrylate, n-octyl acrylate, iso-octyl acrylate, and other alkyl acrylates containing up to 8 carbon atoms in the alkyl groups. Preferably the alkyl acrylate has from 1 to 4 carbon atoms. Preferably the total acrylate content comprises from about 50 to 75 weight % of the copolymer (more preferably from 50 to 70 weight %).

Alternatively a mixture of alkyl acrylates may be used. Preferably, when two or more alkyl acrylates are used, methyl acrylate or ethyl acrylate is used as the first alkyl acrylate and the second alkyl acrylate has from 2 to 8, more preferably 4 to 8, carbon atoms in the alkyl group; provided that when ethyl acrylate is used as the first alkyl acrylate, the second alkyl acrylate has from 3 to 8, more preferably from 4 to 8, carbon atoms in the alkyl group. Notable combinations of alkyl acrylates include combinations of methyl acrylate and a second alkyl acrylate selected from the group consisting of ethyl acrylate, n-butyl acrylate, iso-butyl acrylate, 2-ethylhexyl acrylate, and n-octyl acrylate. Methyl acrylate with n-butyl acrylate and methyl acrylate with 2-ethylhexyl acrylate are preferred combinations.

Small amounts of other comonomers as generally known in the art can be incorporated into the copolymer. Thus for example, it is contemplated that small amounts (a few percent) of alkyl methacrylate comonomer can be used in addition to the alkyl acrylate. Alternatively, an alkyl methacrylate can be used to substitute for the second alkyl acrylate.

The copolymer may contain no cure site component, or higher copolymers may contain 1,4-butene-dioic acid moieties and anhydrides and monoalkyl esters thereof that function as acid cure sites. Of note are acid cure sites that comprise from about 0.5 to about 7 weight percent, preferably from 1 to 6 weight percent, more preferably from 2 to 5 weight percent, of a monoalkyl ester of 1,4-butene-dioic acid, in which the alkyl group of the ester has from 1 to 6 carbon atoms, in the final copolymer. The 1,4-butene-dioic acid and esters thereof exist in either cis or trans form prior to copolymerization, i.e. maleic or fumeric acid. Monoalkyl esters of either are satisfactory. Methyl hydrogen maleate, ethyl hydrogen maleate (EHM), and propyl hydrogen maleate are particularly satisfactory; most preferably EHM is to be employed.

As such, ethylene represents essentially the remainder of the copolymer relative to the required alkyl acrylates and the optional monoalkyl ester of 1,4-butene-dioic acid; i.e., polymerized ethylene is present in the copolymers in a complementary amount.

Examples of copolymers include copolymers of ethylene (E) and methyl acrylate (MA), and copolymers of ethylene (E), methyl acrylate (MA) and ethyl hydrogen maleate (EHM) (E/MA/nBA/EHM).

In another embodiment, the amorphous polyamide may be combined with one or more other polymers by melt compounding prior to producing a solution or dispersion of the polymers in NMP. By melt compounding is meant mixing the polymers at a temperature greater than the glass transition temperature of the amorphous polyamide, and greater than the glass transition temperature and melting peak temperature (where present) of the other polymers. Melt mixing can be advantageous when combining the amorphous polyamide with another polymer comprising amine or acid reactive functional groups such as maleic, citriconic, or itaconic anhydride, or maleic acid or fumaric acid or any of the half esters or diesters, or epoxides such as glycidyl(meth)acrylate, allyl glycidyl ether, glycidyl vinyl ether, or alicyclic epoxy-containing (meth)acrylates. The amine or acid reactive functional groups may be copolymerized or grafted. When amine or acid reactive functional groups are present on the polymer to be combined with amorphous polyamide, melt mixing promotes compatibilization of the polyamide and the other polymer through reaction of the acid and/or amine end groups on the polyamide and the functional group(s) on the other polymer(s). The grafting between amorphous polyamide and a polymer that is otherwise insoluble in NMP can permit solvation or dispersion of the grafted blend in the NMP.

There is no particular limiting level of the other polymers that may be used in combination with amorphous polyamide as a binder for lithium ion battery electrodes. Useful mixtures of polymers with amorphous polyamides for electrode binders include 1 weight % to 99 weight % of PVDF, or 5 weight % to 90 weight % of PVDF, or 10 weight % to 90 weight % of PVDF based on the sum of the amorphous polyamides and PVDF in the mixture. Of note are binder compositions comprising 60 to 99 weight % of amorphous polyamide and 1 to 40 weight % of PVDF, such as 2 weight % to 30 weight % of PVDF, or 5 weight % to 20 weight % of PVDF, based on the sum of the amorphous polyamides and PVDF in the mixture.

Useful mixtures also include amorphous polyamide and 1 weight % to 40 weight % of amorphous polyacrylate elastomer, or 2 weight % to 30 weight % of amorphous polyacrylate elastomer, or 5 weight % to 20 weight % of amorphous polyacrylate elastomer, based on the sum of the amorphous polyamides and amorphous polyacrylate elastomers in the mixture. Compositions of note include those wherein the polyacrylate elastomer comprises from 13 to 50 weight % of copolymerized units of ethylene; from 50 to 80 weight % of copolymerized units of an alkyl acrylate; and from 0 to 7 weight % of copolymerized units of a monoalkyl ester of 1,4-butene-dioic acid.

In addition to binder compositions comprising amorphous polyamide and optionally other polymers described above, the electrode composition for a lithium ion battery also comprises active material capable of reversibly intercalating and deintercalating lithium ions. The active materials of the electrode are in particulate form. There is no particular limiting size of the active material particles. The active material may be in the shape of rods, fiber, spheres, plates, etc., ranging in size from nanoscale (less than 100 nm) to about 100 microns. Typically, active materials have a size distribution ranging from about 1 to 20 microns.

The positive electrode (cathode) active material in the electrode composition can be any one known to one skilled in the art. Examples of cathode active materials include lithium cobalt oxide (LiCoO₂), lithium nickel oxide (LiNiO₂), lithium manganese oxide (LiMn₂O₄), lithiated transition metal oxides such as lithium nickel manganese cobalt oxides (LiNiₓMn_{y}Co_{z}O₂ where x+y+z is about 1), LiCo_{0.2}Ni_{0.2}O₂, Li_{1+z}Ni_{1-x-y}CoₓAl_{y}O₂ where 0<x<0.3, 0<y<0.1, 0<z<0.06; high voltage spinels such as LiNi_{0.5}Mn_{1.5}O₄ and those in which the Ni or Mn are partially substituted with other elements such as Fe, Ga, or Cr; lithium iron oxide, lithium vanadium oxide (LiV₃O₈), lithiated transition metal phosphates such as lithium iron phosphate (LiFePO₄), lithium manganese phosphate (LiMnPO₄), lithium cobalt phosphate (LiCoPO₄), lithium nickel phosphate, and LiVPO₄F; lithium iron borate, and lithium manganese borate. Cathode active materials may also include mixed metal oxides of cobalt, manganese, and nickel such as those described in U.S. Pat. Nos. 6,964,828 and 7,078,128; nanocomposite cathode compositions such as those described in U.S. Pat. No. 6,680,145; lithium-rich layered composite cathodes such as those described in U.S. Pat. No. 7,468,223; and cathodes such as those described in U.S. Pat. No. 7,718,319 and the references therein. Other non-lithium metal compounds can include transition metal sulfides such as TiS₂, TiS₃, MoS₃ and transition metal oxides such as MnO₂, amorphous V₂OP₂O₅, MoO₃, V₂O₅, and V₆O₁₃, copper vanadium oxide (Cu₂V₂O₃), and iron molybdenum oxide.

The negative electrode (anode) active material can be any one known to one skilled in the art. Anode active materials can include without limitation crystalline and amorphous carbon and combinations thereof such as carbon, activated carbon, graphite, natural graphite, mesophase carbon microbeads; lithium alloys and materials which alloy with lithium such as lithium-aluminum alloys, lithium-lead alloys, lithium-silicon alloy, lithium-tin alloy, lithium-antimony alloy and the like; metal oxides including tin oxides such as SnO₂ and SnO, and titanium dioxide (TiO₂); lithium titanates such as Li₄Ti₅O₁₂ and LiTi₂O₄; silicon; silicon oxides; silicon metal oxides and tin. Preferably, the anode active material comprises lithium titanate or graphite.

While the essential ingredients of the electrode composition comprise amorphous polyamide binder and active material, other ingredients may be present.

For example, a dispersant of cationic, anionic, or non-ionic type may be used to improve dispersion of the active materials. In certain embodiments, conductive filler may be added to improve the conductivity of the electrode. Electrical conductivity aids may be also added to the composition to reduce the resistance and increase the capacity of the resulting electrode. Accordingly, an electrode can comprise a metal oxide, mixed metal oxide, metal phosphate, metal salt, or combinations of two or more thereof and a binder composition wherein the binder composition can be as described above, and optionally an electrical conductivity aid. Conductivity aid fillers include carbon black such as acetylene black or furnace black, graphite, carbon nanofiber or nanotubes, or metal powders such as copper, nickel, or silver.

The amorphous polyamide may also be modified with a difunctional chain extender to increase molecular weight. The difunctional chain extender comprises two acid or amine reactive moieties per molecule. Examples of useful chain extenders include dianhydrides or diepoxides such as pyromellitic anhydride, 4,4′-oxydiphthalic anhydride, 3,3′,4,4′-benzophenonetetracarboxylic dianhydride, ethylene glycol diglycidyl ether, or bisphenol A diglycidyl ether. The chain extender may be mixed with the amorphous polyamide at a temperature greater than the glass transition of the amorphous polyamide, or it may be added at any time to the solution of amorphous polyamide in solvent such as NMP or to the slurry comprising solvent, amorphous polyamide, and active material.

The amount of amorphous polyamide binder in the electrode composition may be specified by a weight percent based on the sum of the binders and solid particulate components of the electrode. For the purpose of the weight percent calculation, the solid particulate components of the electrode include active materials and conductive additives, but exclude wetting agents, dispersants, and other ingredients. Preferably, the amorphous polyamide is present in the electrode in the range of 0.1 weight % to 10 weight %, or from 0.5 weight % to 5 weight %, or from 1 weight % to 4 weight %.

The electrode also comprises a substrate known as a current collector on which the mixture comprising active material, amorphous polyamide and solvent is coated. There is no particular limitation of the current collector, so long as it has suitable conductivity for the battery. Typically, the current collector has thickness of about 3 to 500 microns, and comprises iron, aluminum, copper, stainless steel, nickel, titanium, or sintered carbon. In some embodiments, the surface of the current collector may be treated with silver, nickel, titanium, carbon, or other materials to optimize performance.

The invention also provides a process for producing an electrode for a lithium ion battery comprising the steps:
i) providing a composition comprising amorphous polyamide comprising at least 50 mole % of the repeating units derived from one or more aromatic dicarboxylic acids and having a glass transition temperature of at least 80° C.;
ii) providing active material in particulate form, solvent such as NMP, and a current collector;
iii) dissolving the composition comprising amorphous polyamide in the solvent;
iv) mixing the solution comprising amorphous polyamide with active material to form a slurry;
v) applying the slurry comprising amorphous polyamide, active material, and solvent to a current collector; and
vi) removing the solvent to produce an electrode.

For the manufacture of the electrode, the active material(s), amorphous polyamide binder comprising at least 50 mole % of the repeating units derived from one or more aromatic dicarboxylic acids and having a glass transition temperature of at least 80° C., solvent such as NMP, and a current collector are provided.

The method for preparing the electrode composition may comprise mixing the amorphous polyamide binder composition described above with an active material described above such as a metal oxide, mixed metal oxide, metal phosphate, metal salt, or combinations of two or more thereof, and optionally an electrical conductivity aid with a solvent to provide a slurry composition. In general, the slurry composition containing the cathode active material or the anode active material disclosed above can be applied or combined onto a current collector followed by drying the slurry (removing the solvent) thereby providing an electrode.

In one step, the amorphous polyamide is dissolved in the solvent, advantageously by application of heat and agitation. Typical concentrations of amorphous polyamide in the solvent are 1 weight % to 20 weight %, more preferably 5 weight % to 20 weight %, most preferably from 10 weight % to 20 weight %. In another step, the solution comprising amorphous polyamide and solvent such as NMP is combined with particulate active material to form a slurry. There is no particularly limiting amount of solvent in the slurry. The solvent content in the slurry can be adjusted to optimize the process for coating of the current collector.

The cathode active material or the anode active material can be combined with binder composition and the solvent to form a slurry by any means known to one skilled in the art, such as, for example, using a ball mill, sand mill, an ultrasonic disperser, a homogenizer, or a planetary mixer.

In some embodiments, it may be suitable to combine and blend the solvent, amorphous polyamide binder material and active material in a single step without dissolving the amorphous polyamide in the solvent before adding the active material.

In yet another step, the slurry comprising solvent, amorphous polyamide, and active material is applied (coated) onto the current collector. The coating may be performed by dipping, screen printing, silk screening, spray coating, reverse roll coating, direct roll coating, gravure coating, coating using a doctor blade, brush-painting or coating using a slot die. The slurry may be applied in one operation, or using multiple operations.

In the final step of the process, the coated current collector is dried to remove most of the solvent (such as NMP). Typically less than 1 weight % of the solvent present in the slurry remains in the finished electrode, preferably less than 0.5 weight %, most preferably less than 0.1 weight %. Drying can be carried out by any means known to one skilled in the art such as drying with warm or hot air, vacuum drying, infrared drying, freeze drying or drying with electron beams. The thickness of the final dry layer comprising the electrode composition can be in the range of about 0.0001 to about 6 mm, 0.005 to 5 mm, or 0.01 to 3 mm.

The amorphous polyamide composition described herein is useful as a binder composition for use in electrochemical cells such as lithium ion batteries. Accordingly, the invention also provides an electrochemical cell comprising the composition. The electrochemical cell may also comprise a negative electrode (anode), a positive electrode (cathode), an electrolyte and a separator. Other components of a battery may include one or more current collectors as described above, adhered to the electrode composition to carry current. Notably, at least one electrode of the lithium ion battery comprises the amorphous polyamide, particularly wherein the electrode comprises a layer comprising the amorphous polyamide and active material and optionally a conductivity aid applied to a current collector.

An electrochemical cell, battery or lithium ion battery can be produced by any means known to one skilled in the art. Materials for the anode and cathode may include the compositions described above. The electrodes may be prepared as described above.

The electrolyte may be in a gel or liquid form if the electrolyte is an electrolyte that can be used in a lithium ion battery. The electrolyte can be a mixture of organic carbonates containing lithium salts which flow across the separator and carry current through the battery. The organic carbonates can include ethylene carbonate, ethyl methyl carbonate, diethyl carbonate, or combinations thereof. A representative electrolyte comprises a mixture of ethyl methyl carbonate and ethylene carbonate, typically comprising a lithium salt dissolved in solvent. The lithium salts can include LiPF₆, LiBF₄, LiAsF₆, LiClO₄, LiCF₃SO₃, LiN(SO₂CF₃)₂ LiCF₃CO₂, LiB(C₂O₄)₂, LiSbF₆, or combinations thereof. The separator may comprise, or be prepared from, a stretched and thus micro-porous multilayered film of polyethylene, polypropylene or combinations thereof.

The invention is further illustrated by the following examples.

### Examples

### Materials Used

### Binders

B1: Amorphous copolymer of 1,6-hexanediamine, terephthalic acid and isothalic acid, having a glass transition temperature of 130° C. and inherent viscosity of 0.81 dL/g available from DuPont as Selar® PA 3426.
B2: Semi-crystalline polyamide multi-polymer having a melting peak temperature of 156° C., a glass transition temperature of 38° C. and inherent viscosity of 0.93 dL/g available from DuPont as Elvamide® 8061.
B3: PVDF homopolymer available from Arkema Corp. as Kynar® HSV900.

### Other Materials

NMC: The active material is lithium nickel cobalt manganese oxide available from Toda America as NM-3101.
The current collector is aluminum foil, approximately 25 microns thick, available from Allfoils Corp.
NMP: N-methyl-2 pyrrolidone solvent, available from Sigma Aldrich Corp.
Actylene carbon black was used as a conductive additive in the electrodes, available from Denka Kagaku Kogyo Kabushiki Kaisha Corp as Denka Black.

### Test Methods

Peel strength was measured in accordance with ASTM D903-98. Twenty-five mm wide fiber reinforced packing tape Scotch® 893 from Minnesota Mining and Manufacturing Corp. was affixed to the coated side of the electrode. The peel samples were then conditioned for 24 hours at 20° C. at 50% relative humidity. Prior to peel testing, the uncoated side of the current collector was bonded to a stainless steel sheet using double sided tape DCP051A available from Intertape Polymer Co.

Melting peak temperature and glass transition temperature were measured in accordance with ASTM D3418-08.

Inherent viscosity of polyamides was measured per D2857-95, using 96% by weight sulfuric acid as a solvent at a test temperature of 25° C. Samples were dried for 12 hours in a vacuum oven at 80° C. before testing.

### Modified B1

Amorphous polyamide B1 was modified with 15 weight % of an amorphous elastomeric ethylene copolymer comprising 63 weight % of methyl acrylate, 4.7 weight % of the monoethylester of maleic acid, and 32.3 weight % of ethylene by melt mixing in a Haake Rheocord® mixing bowl fitted with roller blades. Temperature setpoint was 200° C., and the blend was mixed for 3 minutes at 50 rpm, after which it was removed and cooled before further processing. The modified amorphous polyamide B1 is denoted “modified B1”.

Solutions of the binders in NMP were prepared by mixing on a hot plate with magnetic stirring according to Table 1. Binder solutions BS1 and BS2 are solutions comprising amorphous polyamides according to the invention.

TABLE 1

| | BS1 | BS2 | BS3 | BS4 |
|---|---|---|---|---|
| Binder solutions | Weight % | | | |
| B1 | 5 | | | |
| modified B1 | | 5 | | |
| B2 | | | 5 | |
| B3 | | | | 10 |
| NMP | 95 | 95 | 95 | 90 |

Electrode slurries S1 through S5 were produced according to the formulations shown in weight percent in Table 2. The slurries were homogenized using a rotor-stator (model PT 10-35GT, 7.5-mm dia. stator, Kinematicia Inc., Bohemia, N.Y.), mixing for 1 minute at 6000 rpm and then for 5 minutes at 9500 rpm. The slurries were then transferred to a planetary centrifugal mixer (ARE-310, Thinky USA Inc., Laguna Hills, Calif.) and mixed at 1000 rpm for two minutes. Slurries S1 through S3 are slurries comprising amorphous polyamides according to the invention.

TABLE 2

| | S1 | S2 | S3 | S4 | S5 |
|---|---|---|---|---|---|
| Slurry | Weight % | | | | |
| BS1 | 24.79 | 17.92 | | | |
| BS2 | | | 34.6 | | |
| BS3 | | | | 30.23 | |
| BS4 | | | | | 20.89 |
| NMC | 68.48 | 69.3 | 47.89 | 44.6 | 37.86 |
| carbon black | 3.78 | 3.82 | 2.64 | 2.49 | 2.09 |
| NMP | 2.95 | 8.96 | 14.87 | 22.68 | 39.16 |

Each electrode slurry, S1 through S5, was coated onto an aluminum foil current collector pre-cleaned with isopropyl alcohol, using a doctor blade. The coated foils were placed in an oven (model FDL-115, Binder Inc., Great River, N.Y.) under a ramping temperature from 30° C. to 100° C. The 12.7-cm wide coated foils were then calendared three times using increasing nip forces of 1080 N, 1440 N, and 1800 N, then further dried under vacuum at 90° C. for 18 hours to produce finished electrodes.

Properties of the finished electrodes are shown in Table 3. Examples E1, E2, and E3 comprise amorphous polyamide binder and exhibit well-adhered coatings of active material on the current collector, with peel strengths of 0.5 N/mm or greater. Example E2 demonstrates that an amorphous polyamide binder can provide four times greater peel strength than a conventional PVDF binder (Comparative Example CE2) at approximately one-half of the binder loading in the electrode. Comparative Example CE1, comprising a semi-crystalline polyamide binder, had extremely poor adhesion to the current collector at equivalent binder loading to example E1.

TABLE 3

| Electrodes | E1 | E2 | E3 | CE1 | CE2 |
|---|---|---|---|---|---|
| Slurry Solution | S1 | S2 | S3 | S4 | S5 |
| Thickness (microns) | 50.8 | 45.7 | 48.3 | 86.4 | 50.8 |
| Binder content (weight %) | 3.3 | 2.4 | 3.3 | 3.3 | 5 |
| Average Peel load (N/mm) | 1.3 | 1.2 | 0.5 | 0 | 0.3 |

What is claimed is:

1. A composition for an electrode of a lithium ion battery comprising discrete particles of active material dispersed in a binder composition comprising an amorphous polyamide, wherein the amorphous polyamide comprises at least 50 mole % of the repeating units derived from one or more aromatic dicarboxylic acids and has a glass transition temperature of at least 80° C.

2. The composition of claim 1 wherein the active material comprises a lithium metal oxide, mixed metal oxide, or metal salt.

3. The composition of claim 2 wherein the active material comprises lithium cobalt oxide, lithium nickel oxide, lithium manganese oxides, lithium nickel manganese cobalt oxides, lithium iron oxide, lithium vanadium oxide, lithium iron phosphate, lithium manganese phosphate, lithium cobalt phosphate, lithium nickel phosphate, lithium iron borate, lithium manganese borate, copper vanadium oxide, or iron molybdenum oxide.

4. The composition of claim 1 wherein the active material comprises crystalline or amorphous carbon or combinations thereof, silicon, silicon oxide, silicon metal oxide, titanium dioxide, lithium titanium oxide, tin, or tin oxide.

5. The composition of claim 1 wherein the amorphous polyamide comprises at least 75 mole % of repeating units derived from one or more aromatic dicarboxylic acids.

6. The composition of claim 1 wherein the aromatic dicarboxylic acid comprises terephthalic acid, isophthalic acid or orthophthalic acid.

7. The composition of claim 1 wherein the diamine component of the amorphous polyamide comprises one or more aliphatic diamines.

8. The composition of claim 1 wherein the diamine component of the amorphous polyamide comprises ethylene diamine, 1,4-butanediamine, 1,6-hexanediamine, trimethyl-1,6-hexanediamine.

9. The composition of claim 8 wherein the diamine component of the amorphous polyamide comprises 1,6-hexanediamine or trimethyl-1,6-hexanediamine.

10. The composition of claim 1 wherein the amorphous polyamide comprises 1,6-hexanediamine, terephthalic acid and isothalic acid.

11. The composition of claim 1 wherein the binder composition further comprises PVDF; a vinylidene fluoride or vinyl fluoride copolymer of hexafluoropropylene, tetrafluoroethylene, or perfluoromethylvinyl ether; polymethyl methacrylate; polyacrylate polymer comprising methyl acrylate, ethyl acrylate, butyl acrylate, hexyl acrylate, 2-ethylhexylacrylate or 2-methoxyethyl acrylate; or a copolymer of ethylene and vinyl acetate comprising at least 40 weight % of vinyl acetate.

12. The composition of claim 11 wherein the polyacrylate polymer is an amorphous elastomer comprising methyl acrylate, ethyl acrylate, or butyl acrylate, 2-methoxyethylacrylate and less than 80 mole % ethylene.

13. The composition of claim 12 wherein the amorphous elastomer comprises
(a) from 13 to 50 weight % of copolymerized units of ethylene;
(b) from 50 to 80 weight % of copolymerized units of an alkyl acrylate; and
(c) from 0 to 7 weight % of copolymerized units of a monoalkyl ester of 1,4-butene-dioic acid, wherein all weight percentages are based on total weight of components (a) through (c) in the copolymer.

14. The composition of claim 1 wherein the binder composition further comprises a polymer comprising an amine or acid reactive functional group.

15. The composition of claim 14 wherein the amine or acid reactive functional group comprises maleic, citriconic, or itaconic anhydride; maleic acid or fumaric acid or any of the half esters or diesters; glycidyl(meth)acrylate; allyl glycidyl ether; glycidyl vinyl ether; or alicyclic epoxy-containing (meth)acrylate.

16. An electrode for a lithium ion battery comprising a layer of the composition of claim 1 coated on the surface of a current collector.

17. The electrode of claim 16 wherein the current collector comprises iron, aluminum, copper, stainless steel, nickel, titanium, or sintered carbon.

18. An electrochemical cell comprising the composition of claim 1.

19. The electrochemical cell of claim 18 comprising a negative electrode, a positive electrode, an electrolyte and a separator, wherein the negative electrode, positive electrode or both comprise a layer of the composition of claim 1 coated on the surface of a current collector.

20. A process for producing an electrode for a lithium ion battery comprising the composition of claim 1, comprising the steps:
i) providing a composition comprising amorphous polyamide comprising at least 50 mole % of the repeating units derived from one or more aromatic dicarboxylic acids and having a glass transition temperature of at least 80° C.;
ii) providing active material in particulate form, solvent, and a current collector;
iii) dissolving the composition comprising amorphous polyamide in the solvent;
iv) mixing the solution comprising amorphous polyamide with active material to form a slurry;
v) applying the slurry comprising amorphous polyamide, active material, and solvent to a current collector; and
vi) removing the solvent to produce an electrode.
vii) comprising the composition of claim 1.

21. The process of claim 20 wherein the solvent is N-methyl-2-pyrrolidone.

22. The process of claim 21 wherein the amorphous polyamide comprises at least 75 mole % of repeating units derived from one or more aromatic dicarboxylic acids.

23. The process of claim 21 wherein the aromatic dicarboxylic acid comprises terephthalic acid, isophthalic acid or orthophthalic acid.

24. The process of claim 21 wherein the diamine component of the amorphous polyamide comprises one or more aliphatic diamines.

25. The process of claim 24 wherein the diamine component of the amorphous polyamide comprises ethylene diamine, 1,4-butanediamine, 1,6-hexanediamine, trimethyl-1,6-hexanediamine.

26. The process of claim 21 wherein the amorphous polyamide composition further comprises PVDF; a vinylidene fluoride or vinyl fluoride copolymer of hexafluoropropylene, tetrafluoroethylene, or perfluoromethylvinyl ether; polymethyl methacrylate; polyacrylate polymer comprising methyl acrylate, ethyl acrylate, butyl acrylate, hexyl acrylate, 2-ethylhexylacrylate or 2-methoxyethyl acrylate; or a copolymer of ethylene and vinyl acetate comprising at least 40 weight % of vinyl acetate.
